(19) United States
(12) Patent Application Publication
(10) Pub. No.: US 2026/0302509 A1
(43) Pub. Date: Oct. 1, 2026

(54) SECONDARY BATTERY

(71) Applicant: MURATA MANUFACTURING CO., LTD., Kyoto (JP)

(72) Inventors: Kunio SODEYAMA, Kyoto (JP); Shunya MIYAZAKI, Kyoto (JP)

(21) Appl. No.: 19/435,141

(22) Filed: Dec. 29, 2025

(30) Foreign Application Priority Data
Mar. 26, 2025 (JP) 2025-052357

(51) Int. Cl. H01M 50/342; H01M 50/107; H01M 50/152; H01M 50/167

(52) U.S. Cl. CPC H01M 50/3425; H01M 50/107; H01M 50/152; H01M 50/167

(57) ABSTRACT

A secondary battery includes a battery device, a container, a cover member, and a valve member. The container contains the battery device. The cover member and the valve member are attached to the container to close a first end part, with an insulating member interposed therebetween. The valve member is positioned between the cover member and the battery device. The cover member includes a first flange and a first middle part. The valve member includes a second flange in contact with the first flange in a first direction, and a second middle part spaced from and opposed to the first middle part in the first direction. The second middle part includes a cleavage valve including a depressed part depressed relative to the cover member. The secondary battery satisfies Expressions (1) and (2) below:

$$0.21 \leq D 1 / D 2 \leq 0 \text{.68} \qquad ( 1 )$$

$$0.19 \leq H 1 / D 2 \leq 0 \text{.35} . \qquad ( 2 )$$

### CROSS-REFERENCE TO RELATED APPLICATIONS

The present application claims priority from Japanese Patent Application No. 2025-052357 filed on Mar. 26, 2025, the entire contents of which are hereby incorporated by reference.

### BACKGROUND

The present disclosure relates to a secondary battery including a safety valve mechanism.

Various kinds of electronic equipment, including mobile phones, have been widely used. Such widespread use has invoked a need for a smaller size, a lighter weight, and a longer life of the electronic equipment. To address the need, a secondary battery having a smaller size, a lighter weight, and a longer life has been developed as a power source of the electronic equipment.

A secondary battery includes a positive electrode, a negative electrode, and an electrolytic solution. In order to suppress occurrence of malfunction due to a gas when the gas is generated due to, for example, a decomposition reaction of the electrolytic solution, the secondary battery includes a safety valve mechanism configured to release the gas to an outside on an as-needed basis.

### SUMMARY

The present disclosure relates to a secondary battery including a safety valve mechanism.

Consideration has been given in various ways to improve performance of a secondary battery. There is, however, still room for improvement in terms of the performance of the secondary battery.

It is desirable to provide a secondary battery that is superior in safety.

A secondary battery according to an embodiment of the present disclosure includes a battery device, a container, a cover member, and a valve member.

The container contains the battery device. The container includes a first end part and a second end part. The first end part is open. The second end part is positioned on an opposite side to the first end part in a first direction and closed. The cover member is attached to the container to close the first end part, with an insulating member interposed between the container and the cover member. The valve member is attached to the container to close the first end part, with the insulating member interposed between the container and the valve member. The valve member is positioned between the cover member and the battery device in the first direction. The cover member includes a first flange and a first middle part. The first flange is annular in plan shape along a plane orthogonal to the first direction. The first middle part is surrounded by the first flange along the plane. The valve member includes a second flange and a second middle part. The second flange is annular in plan shape along the plane, and is in contact with the first flange in the first direction. The second middle part is surrounded by the second flange along the plane, and is spaced from and opposed to the first middle part in the first direction. The second middle part includes a cleavage valve including a depressed part depressed relative to the cover member. The secondary battery satisfies Expressions (1) and (2) below.

$$0.21 \leq D 1 / D 2 \leq 0 \text{.68} \qquad ( 1 )$$

$$0.19 \leq H 1 / D 2 \leq 0.35 \qquad ( 2 )$$

where:
D1 represents a maximum diameter of the depressed part along the plane;
D2 represents a maximum diameter, along the plane, of a space provided between the first middle part and the second middle part; and
H1 represents a dimension of the space in the first direction.

### BRIEF DESCRIPTION OF THE DRAWINGS

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating an overall configuration example of a secondary battery according to an embodiment of the present disclosure.

FIG. 2 is an enlarged partial sectional diagram illustrating a configuration example of an upper part of the secondary battery illustrated in FIG. 1.

FIG. 3 is an enlarged sectional diagram illustrating a configuration example of a battery cover and a safety cover of the secondary battery illustrated in FIG. 1.

FIG. 4 is a perspective view of the safety cover illustrated in FIG. 2.

FIG. 5 is a schematic plan view of the safety cover illustrated in FIG. 2.

FIG. 6 is an enlarged sectional diagram illustrating an encircled part in FIG. 3.

FIG. 7 is an enlarged sectional diagram illustrating a partial configuration of a battery device illustrated in FIG. 1.

FIG. 8A is a first sectional diagram for describing an operation of the secondary battery.

FIG. 8B is a second sectional diagram for describing the operation of the secondary battery.

FIG. 9 is an enlarged partial sectional diagram illustrating a configuration example of an upper part of a secondary battery according to an embodiment.

FIG. 10 is a block diagram illustrating a configuration of a battery pack as an application example of the secondary battery.

FIG. 11 is a schematic diagram illustrating an outline configuration of a safety valve cleavage measurement apparatus for use in evaluating Examples.

FIG. 12 is an enlarged partial sectional diagram illustrating a configuration example of an upper part of a secondary battery according to an embodiment.

FIG. 13A is an enlarged partial sectional diagram illustrating a configuration example of an upper part of a secondary battery according to a first reference example.

FIG. 13B is a sectional diagram for describing an operation of the secondary battery according to the first reference example.

FIG. 14A is an enlarged partial sectional diagram illustrating a configuration example of an upper part of a secondary battery according to a second reference example.

FIG. 14B is a sectional diagram for describing an operation of the secondary battery according to the second reference example.

### DETAILED DESCRIPTION

The present disclosure relates to a secondary battery including a safety valve mechanism.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an example embodiment of the present disclosure.

Although a charge and discharge principle of the secondary battery described herein is not particularly limited, the following description deals with a case where a battery capacity is obtained through insertion and extraction of an electrode reactant.

The secondary battery may include a positive electrode, a negative electrode, and an electrolyte. In the secondary battery, a charge capacity of the negative electrode may be greater than a discharge capacity of the positive electrode. For example, an electrochemical capacity per unit area of the negative electrode may be greater than an electrochemical capacity per unit area of the positive electrode. One reason for this is to prevent precipitation of the electrode reactant on a surface of the negative electrode during charging.

Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

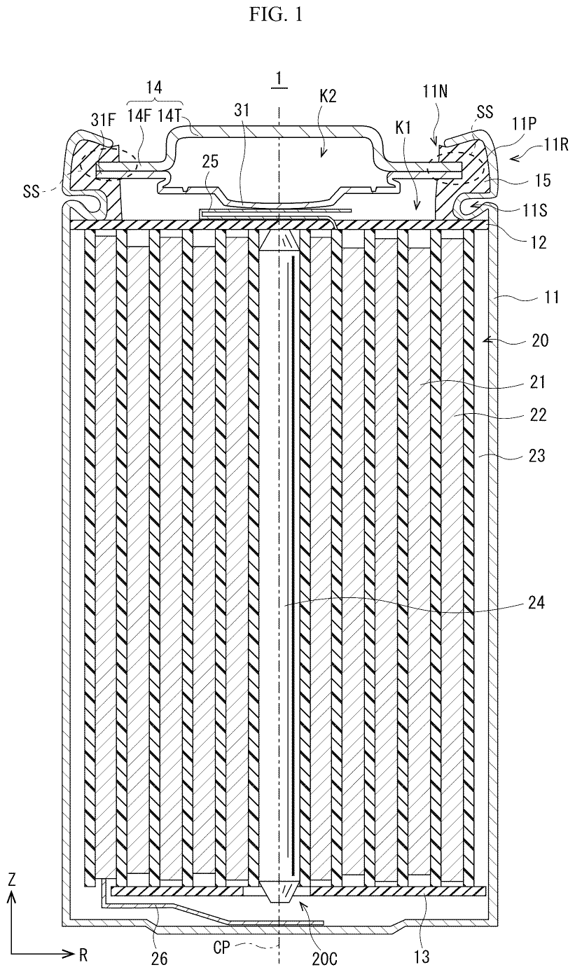

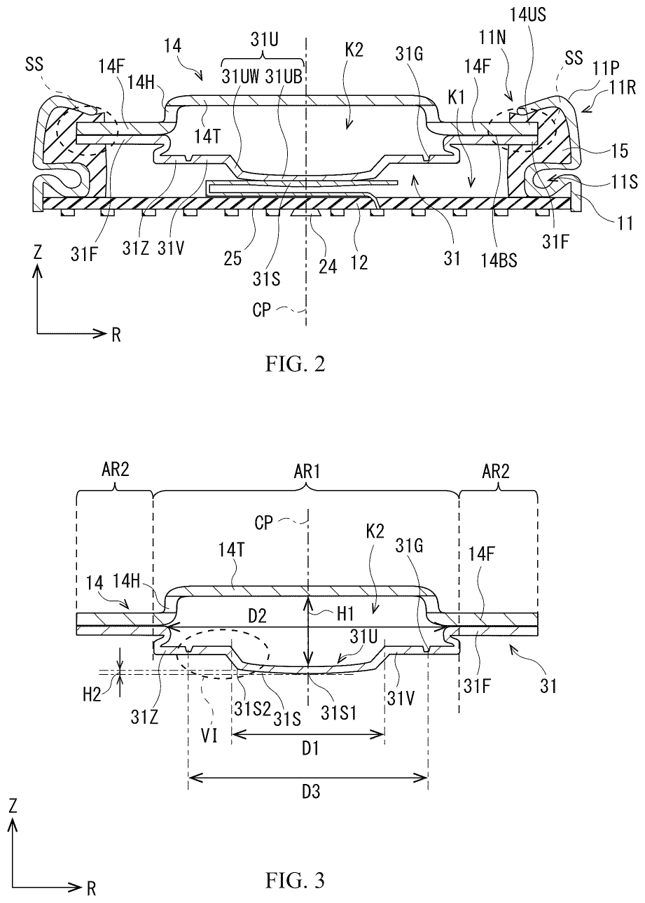

FIG. 1 illustrates an overall sectional configuration of a secondary battery 1 according to an example embodiment of the present disclosure. FIG. 2 illustrates a partial sectional configuration of the secondary battery 1 illustrated in FIG. 1, and more specifically, illustrates a sectional configuration of a battery cover 14 and a safety cover 31 to be described later, and the vicinity thereof. FIG. 3 illustrates the sectional configuration of the battery cover 14 and the safety cover 31. The secondary battery 1 may be what is called a cylindrical secondary battery. As illustrated in FIG. 1, the secondary battery 1 may include a battery can 11 having a cylindrical shape, and a battery device 20 contained in a space K1 inside the battery can 11. A reference sign CP denotes a central axis of the secondary battery 1.

Hereinafter, a direction in which the battery device 20 is placed into the battery can 11, i.e., a height direction of the battery can 11 having the cylindrical shape, will be referred to as a Z direction, and a radial direction of the battery can 11 having the cylindrical shape will be referred to as an R direction.

The Z direction may correspond to a specific but non-limiting example of a “first direction” in an embodiment of the present disclosure.

For example, in the secondary battery 1 illustrated in FIG. 1, a pair of insulating plates 12 and 13 and the battery device 20 may be contained inside the battery can 11 having the cylindrical shape. A safety cover 31 and a battery cover 14 are attached to the battery can 11. The safety cover 31 may serve as a safety valve mechanism. The battery can 11 may be sealed by the battery cover 14, for example. In some embodiments, the secondary battery 1 may further include components including, without limitation, a thermosensitive resistive device and a reinforcing member inside the battery can 11. Non-limiting examples of the thermosensitive resistive device may include a positive temperature coefficient (PTC) device. In the secondary battery 1 illustrated in FIG. 1, an end part in the Z direction on a side on which the battery cover 14 is provided may be referred to as an upper part, and an end part in the Z direction on an opposite side to the battery cover 14 may be referred to as a lower part.

The battery can 11 may correspond to a specific but non-limiting example of a “container” in an embodiment of the present disclosure. The battery cover 14 may correspond to a specific but non-limiting example of a “cover member” in an embodiment of the present disclosure.

The battery can 11 may be a container having a hollow structure that extends in the Z direction. The battery can 11 includes a first end part in the Z direction, and a second end part positioned on an opposite side to the first end part in the Z direction. The first end part is open and the second end part is closed. The first end part of the battery can 11 in the Z direction may be an open end part 11N. The battery can 11 may include, for example, any one or more of metal materials including, without limitation, iron, aluminum, and alloys thereof. The battery can 11 may have a surface plated with, for example, any one or more of metal materials including, without limitation, nickel. In some embodiments, the battery can 11 may include an iron-based material including iron (Fe), such as stainless steel. One reason for this is that this secures physical strength of the battery can 11, which helps to suppress detachment of the battery cover 14 and leakage of an electrolytic solution even when an internal pressure of the battery can 11 increases. Non-limiting examples of the stainless steel may include SUS304 and SUS430.

The pair of insulating plates 12 and 13 may be disposed with the battery device 20 interposed therebetween in the Z direction, and may extend along a plane orthogonal to the Z direction.

The battery cover 14 and the safety cover 31 may be crimped at the open end part 11N of the battery can 11, with a gasket 15 interposed between the open end part 11N and both the battery cover 14 and the safety cover 31. The battery can 11 may be provided with a bent part 11P defining the open end part 11N.

The open end part 11N of the battery can 11 may be sealed by the battery cover 14 in a state where the battery device 20 and other components are contained inside the battery can 11. The battery can 11 may have a crimped structure 11R provided in the vicinity of the open end part 11N. The crimped structure 11R may be a structure in which the bent part 11P defining the open end part 11N and both the battery cover 14 and the safety cover 31 are crimped to each other with the gasket 15 interposed between the bent part 11P and both the battery cover 14 and the safety cover 31. A narrow part 11S may be provided between the bent part 11P and the insulating plate 12. The narrow part 11S may be a part of the battery can 11 that protrudes inward.

The bent part 11P may correspond to a specific but non-limiting example of a “crimp part” in an embodiment of the present disclosure.

The battery cover 14 closes the open end part 11N of the battery can 11. The battery cover 14 is attached to the bent part 11P to close the open end part 11N, with the gasket 15 interposed between the battery cover 14 and the bent part 11P. In some embodiments, the battery cover 14 may include a material similar to the material included in the battery can 11. In some embodiments, the battery cover 14 may include a material different from the material included in the battery can 11. Further, in some embodiments, as illustrated in FIGS. 2 and 3, the battery cover 14 may have a through hole 14H.

In some embodiments, the battery cover 14 may include an iron-based material including iron (Fe), such as stainless steel. One reason for this is that this secures physical strength of the battery cover 14 and accordingly secures physical strength of the crimped structure 11R, which helps to suppress the detachment of the battery cover 14 and the leakage of the electrolytic solution even when the internal pressure of the battery can 11 increases. Non-limiting examples of the stainless steel may include SUS304 and SUS430.

The battery cover 14 includes a protruding part 14T. The protruding part 14T may occupy a middle region AR1 of the secondary battery 1 along the plane orthogonal to the Z direction. The protruding part 14T may protrude in a direction away from the battery device 20, i.e., in a +Z direction. The battery cover 14 further includes a flange 14F that is annular in plan shape along the plane orthogonal to the Z direction. The flange 14F may be provided in a peripheral region AR2 of the secondary battery 1. The peripheral region AR2 may surround the middle region AR1 along the plane orthogonal to the Z direction. The flange 14F of the battery cover 14 may be opposed, in the Z direction, to a flange 31F of the safety cover 31 serving as the safety valve mechanism, and may be joined to the flange 31F. The flange 31F will be described later. A part in which the flange 14F and the flange 31F are joined to each other by a method such as a welding method will be referred to as a stacked part SS.

The protruding part 14T may correspond to a specific but non-limiting example of a “first middle part” in an embodiment of the present disclosure. The flange 14F may correspond to a specific but non-limiting example of a “first flange” in an embodiment of the present disclosure.

The gasket 15 may be a sealing member that seals a gap between the bent part 11P and both the battery cover 14 and the safety cover 31. The gasket 15 may be interposed between the bent part 11P of the battery can 11 and the battery cover 14.

The gasket 15 may correspond to a specific but non-limiting example of an “insulating member” in an embodiment of the present disclosure.

The gasket 15 may include any one or more of insulating materials. Non-limiting examples of the insulating materials may include a polymer material such as polybutylene terephthalate (PBT) or polypropylene (PP). In some embodiments, the gasket 15 may include polypropylene. One reason for this is that this helps to allow for sufficient sealing of the gap between the bent part 11P and both the battery cover 14 and the safety cover 31, with the battery can 11 and the battery cover 14 being electrically separated from each other.

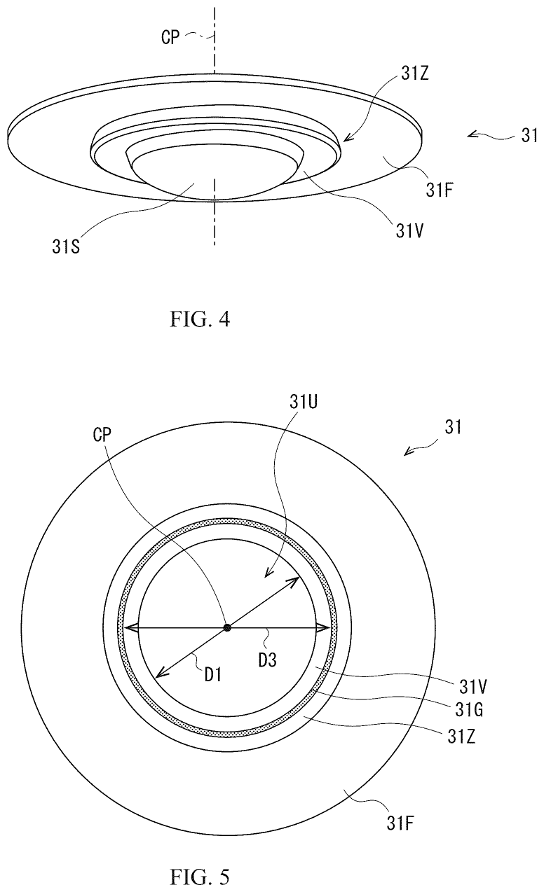

The safety cover 31 serving as the safety valve mechanism may be provided on an inner side of the battery cover 14 in the Z direction, and may be, for example, positioned between the battery cover 14 and the battery device 20. The safety cover 31 may be a mechanism that releases the internal pressure of the battery can 11 by unsealing the battery can 11 on an as-needed basis when the internal pressure increases. Non-limiting examples of a cause of the increase in the internal pressure of the battery can 11 may include a gas generated due to a decomposition reaction of the electrolytic solution upon charging and discharging. An example detailed configuration of the safety cover 31 will be described later with reference to FIGS. 2 and 3, and to FIGS. 4 and 5 to be described later.

The battery device 20 may be contained inside the battery can 11, and may include a positive electrode 21, a negative electrode 22, and an electrolytic solution, which is an electrolyte in liquid form, i.e., a liquid electrolyte. Note that the electrolyte is not limited to the liquid electrolyte. In some embodiments, the electrolyte may be a gel electrolyte, for example.

Here, the battery device 20 may be what is called a wound electrode body. In the battery device 20, the positive electrode 21 and the negative electrode 22 may be stacked on each other with a separator 23 interposed therebetween, and the stack of the positive electrode 21, the negative electrode 22, and the separator 23 may be wound. The positive electrode 21, the negative electrode 22, and the separator 23 may each be impregnated with the electrolytic solution.

The battery device 20 may have, at a center thereof, a center space 20C that is a space resulting from winding the positive electrode 21, the negative electrode 22, and the separator 23. A center pin 24 may be disposed in the center space 20C. In some embodiments, however, the center pin 24 may be omitted.

A positive electrode lead 25 may be coupled to the positive electrode 21. A negative electrode lead 26 may be coupled to the negative electrode 22. The positive electrode lead 25 may include any one or more of electrically conductive materials including, without limitation, a metal material. Non-limiting examples of the metal material included in the positive electrode lead 25 may include aluminum. The positive electrode lead 25 may be electrically coupled to the battery cover 14 via the safety cover 31. The negative electrode lead 26 may include any one or more of electrically conductive materials including, without limitation, a metal material. Non-limiting examples of the metal material included in the negative electrode lead 26 may include nickel. The negative electrode lead 26 may be electrically coupled to the battery can 11.

An example detailed configuration of the battery device 20, i.e., an example detailed configuration of each of the positive electrode 21, the negative electrode 22, the separator 23, and the electrolytic solution, will be described later with reference to FIG. 7.

FIG. 4 is a perspective diagram illustrating an outer appearance of the safety cover 31. FIG. 5 is a schematic plan view of the safety cover 31, and illustrates a state where the safety cover 31 is viewed in the Z direction from a side opposite to the battery device 20.

As illustrated in FIG. 2, the safety cover 31 is positioned between the battery cover 14 and the battery device 20 in the Z direction. The safety cover 31 may be opposed to a lower surface 14BS of the battery cover 14. The safety cover 31 may be partly cleavable in response to the increase in the internal pressure of the battery can 11. The safety cover 31 may include a cleavage valve 31V in the middle region AR1 of the secondary battery 1. The cleavage valve 31V may be cleavable in response to the increase in the internal pressure of the battery can 11. The cleavage valve 31V may have an outer edge defined by a groove 31G provided in the middle region AR1. The groove 31G may be provided in a surface, of the safety cover 31, opposed to the battery cover 14 and may extend in an annular shape along the plane orthogonal to the Z direction. When the safety cover 31 cleaves, a part of the cleavage valve 31V may cleave, or all of the cleavage valve 31V may be detached from a part of the safety cover 31 other than the cleavage valve 31V, such as an annular protrusion 31Z to be described later.

The safety cover 31 may correspond to a specific but non-limiting example of a “valve member” in an embodiment of the present disclosure. The cleavage valve 31V may correspond to a specific but non-limiting example of a “cleavage valve” in an embodiment of the present disclosure.

In the middle region AR1 of the secondary battery 1, the safety cover 31 may further include the annular protrusion 31Z. The annular protrusion 31Z may so extend as to surround the cleavage valve 31V. The cleavage valve 31V and the annular protrusion 31Z may correspond to a specific but non-limiting example of a “second middle part” in an embodiment of the present disclosure. The groove 31G may be provided at a border part between the cleavage valve 31V and the annular protrusion 31Z. A depressed part 31U may be provided at a center position of the cleavage valve 31V, i.e., a position that overlaps the central axis CP. The depressed part 31U may be depressed in a direction away from the protruding part 14T of the battery cover 14 along the Z direction, that is, depressed in a −Z direction. In other words, the depressed part 31U may protrude downward, from the cleavage valve 31V toward the battery device 20. The depressed part 31U may include a bottom part 31UB and a wall part 31UW, for example, as illustrated in FIG. 2. The wall part 31UW may be provided in a standing state along an outer edge of the bottom part 31UB. A lower surface of the bottom part 31UB of the depressed part 31U may be an opposed surface 31S opposed to the battery device 20. The opposed surface 31S may include a curved surface protruding toward the battery device 20. Note that FIGS. 1 to 4 illustrate an example of the cleavage valve 31V in which the opposed surface 31S is entirely a curved surface. The opposed surface 31S of the depressed part 31U may be joined to the positive electrode lead 25 to be described later. When the opposed surface 31S includes the curved surface protruding toward the battery device 20, it is easier to establish a favorable joined state of the opposed surface 31S to the positive electrode lead 25.

In the peripheral region AR2 of the secondary battery 1, the safety cover 31 further includes the flange 31F. The flange 31F may be a circular annular part that is positioned on an outer side of the annular protrusion 31Z in the R direction, and that is annular in plan shape along the plane orthogonal to the Z direction. The flange 31F may overlap the flange 14F of the battery cover 14 in the Z direction. The flange 31F and the flange 14F may configure the stacked part SS.

The flange 31F may correspond to a specific but non-limiting example of a “second flange” in an embodiment of the present disclosure.

The safety cover 31 may include any one or more of electrically conductive materials including, without limitation, a metal material. Non-limiting examples of the metal material may include aluminum and an aluminum alloy. A plan shape of an outer edge of the safety cover 31, i.e., an outer edge of the flange 31F, is not particularly limited, and may be circular, for example. In some embodiments, a plan shape of each of the annular protrusion 31Z, the cleavage valve 31V, and the depressed part 31U may also be circular. The “plan shape” may refer to a shape along the plane orthogonal to the Z direction. The definition of the plan shape given here is similarly applicable to the rest of the description.

The secondary battery 1 satisfies Expressions (1) and (2) below.

$$0.21 \leq D 1 / D 2 \leq 0 \text{.68} \qquad ( 1 )$$

$$0.19 \leq H 1 / D 2 \leq 0.35 \qquad ( 2 )$$

As illustrated in FIG. 3, D1 represents a maximum diameter of the depressed part 31U along the plane orthogonal to the Z direction, and D2 represents a maximum diameter, along the plane orthogonal to the Z direction, of a space K2 provided between the protruding part 14T of the battery cover 14 and both the cleavage valve 31V and the annular protrusion 31Z in the middle region AR1. Further, H1 represents a dimension of the space K2 in the Z direction, i.e., a height of the space K2.

In some embodiments, the secondary battery 1 may further satisfy Expression (3) below.

$$1. 46 \leq D 3 / D 1 \leq 1.87 \qquad ( 3 )$$

As illustrated in FIGS. 3 and 5, D3 represents a maximum diameter of the cleavage valve 31V along the plane orthogonal to the Z direction.

In some embodiments, in the secondary battery 1, a distance H2 in the Z direction between an apex 31S1 of the opposed surface 31S as a curved surface and an outer edge 31S2 of the opposed surface 31S may be, for example, greater than or equal to 5 μm and less than or equal to 20 μm. See FIG. 3.

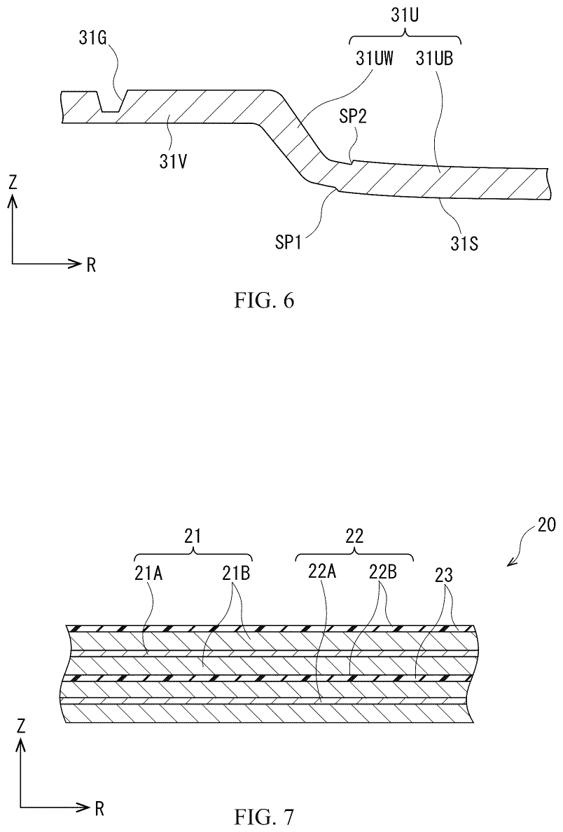

In some embodiments, in the secondary battery 1, as illustrated in FIG. 6, the depressed part 31U may include a stepped part SP1 in an outer edge region of the opposed surface 31S along the plane orthogonal to the Z direction. FIG. 6 is an enlarged sectional diagram illustrating an encircled part V1 of the safety cover 31 bounded by a broken line in FIG. 3. As described above, the depressed part 31U of the safety cover 31 may include, for example, the bottom part 31UB including the opposed surface 31S, and the wall part 31UW provided in the standing state along the outer edge of the bottom part 31UB. The stepped part SP1 may be provided at a border part between the bottom part 31UB and the wall part 31UW in the opposed surface 31S, for example. In some embodiments, as illustrated in FIG. 6, the depressed part 31U may further include a stepped part SP2 in an inner surface thereof, i.e., a surface opposed to the battery cover 14. In a configuration example of the depressed part 31U illustrated in FIG. 6, the stepped parts SP1 and SP2 may be provided in a region, of the bottom part 31UB, including the outer edge of the bottom part 31UB and the vicinity of the outer edge thereof. Thus, the bottom part 31UB may have a smaller thickness in the above-described region of the bottom part 31UB than in a remaining region of the bottom part 31UB. Thus, the depressed part 31U may include a narrow part in the region, of the bottom part 31UB, including the outer edge of the bottom part 31UB and the vicinity of the outer edge thereof. Such a narrow part may be formed by locally performing compression processing, for example. Accordingly, when the narrow part including the stepped parts SP1 and SP2 is present, work hardening may have occurred in the above-described region of the bottom part 31UB of the depressed part 31U, which may allow such a region to be more resistant to deformation than other regions of the depressed part 31U, even when an external force is applied thereto.

As illustrated in FIG. 2, the flange 14F of the battery cover 14 and the flange 31F of the safety cover 31 may be welded to each other to configure the stacked part SS. The stacked part SS may be pinched by the bent part 11P in the Z direction, with the gasket 15 interposed between the bent part 11P and the stacked part SS. For example, the battery cover 14 and the safety cover 31 may be attached to the bent part 11P, with the gasket 15 interposed between the bent part 11P and both the battery cover 14 and the safety cover 31. In some embodiments, the stacked part SS may include a weld mark extending in the Z direction across an interface between the flange 14F and the flange 31F. The weld mark may be formed by, for example, irradiation of an energetic beam such as a laser beam or an electron beam. The weld mark may be a part in which a metal material included in the battery cover 14, such as nickel-plated stainless steel, and a metal material included in the safety cover 31, such as aluminum or an aluminum alloy, are mixed with each other to form a solid solution.

FIG. 7 illustrates an enlarged view of a part of a sectional configuration of the battery device 20 illustrated in FIG. 1. The battery device 20 may include the positive electrode 21, the negative electrode 22, the separator 23, and the electrolyte, as described above.

The positive electrode 21 may include, as illustrated in FIG. 7, a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the metal material may include aluminum.

In an example illustrated in FIG. 7, the positive electrode active material layer 21B may be provided on each of the two opposed surfaces of the positive electrode current collector 21A. The positive electrode active material layer 21B may include any one or more of positive electrode active materials into which lithium is insertable and from which lithium is extractable. In some embodiments, the positive electrode active material layer 21B may be provided simply on one of the two opposed surfaces of the positive electrode current collector 21A, on a side on which the positive electrode 21 is opposed to the negative electrode 22. In some embodiments, the positive electrode active material layer 21B may further include materials including, without limitation, a positive electrode binder and a positive electrode conductor. A method of forming the positive electrode active material layer 21B is not particularly limited, and may be, for example, a method such as a coating method.

The positive electrode active material may include a lithium compound. The lithium compound may be a compound including lithium as a constituent element, and may be, for example, a compound including lithium and one or more transition metal elements as constituent elements. One reason for this is that this helps to obtain a high energy density. In some embodiments, the lithium compound may further include any one or more of other elements, i.e., elements other than lithium and the transition metal elements.

The lithium compound is not particularly limited in kind, and non-limiting examples thereof may include a lithium composite oxide having a layered rock-salt crystal structure, a lithium composite oxide having a spinel crystal structure, and a lithium phosphoric acid compound having an olivine crystal structure. Non-limiting examples of the lithium composite oxide having the layered rock-salt crystal structure may include LiNiO₂, LiNi_{0.8}Co_{0.15}Al_{0.05}, and LiCoO₂. Non-limiting examples of the lithium composite oxide having the spinel crystal structure may include LiMn₂O₄. Non-limiting examples of the lithium phosphoric acid compound having the olivine crystal structure may include LiFePO₄ and LiMnPO₄.

In some embodiments, the positive electrode active material may include the lithium phosphoric acid compound having the olivine crystal structure. One reason for this is that the lithium phosphoric acid compound having the olivine crystal structure is thermally stable in crystal structure, and therefore helps to prevent the secondary battery from easily exhibiting thermal runaway due to a cause such as overcharging or an internal short circuit. Another reason is that the lithium phosphoric acid compound having the olivine crystal structure is firm in crystal structure, and therefore helps to prevent the battery capacity from easily decreasing even if the secondary battery is charged and discharged repeatedly.

The positive electrode binder may include any one or more of materials including, without limitation, a synthetic rubber and a polymer compound. Non-limiting examples of the synthetic rubber may include a styrene-butadiene-based rubber. Non-limiting examples of the polymer compound may include polyvinylidene difluoride.

The positive electrode conductor may include any one or more of electrically conductive materials including, without limitation, a carbon material. Non-limiting examples of the carbon material may include graphite, carbon black, acetylene black, and Ketjen black. In some embodiments, the electrically conductive material may be a metal material or a polymer compound, for example.

The negative electrode 22 may include, as illustrated in FIG. 7, a negative electrode current collector 22A and a negative electrode active material layer 22B.

The negative electrode current collector 22A may have two opposed surfaces on each of which the negative electrode active material layer 22B is to be provided. The negative electrode current collector 22A may include an electrically conductive material such as a metal material. Non-limiting examples of the metal material may include copper.

Here, the negative electrode active material layer 22B may be provided on each of the two opposed surfaces of the negative electrode current collector 22A, and may include any one or more of negative electrode active materials into which lithium is insertable and from which lithium is extractable. In some embodiments, the negative electrode active material layer 22B may be provided simply on one of the two opposed surfaces of the negative electrode current collector 22A, on a side on which the negative electrode 22 is opposed to the positive electrode 21. In some embodiments, the negative electrode active material layer 22B may further include materials including, without limitation, a negative electrode binder and a negative electrode conductor. Details of the negative electrode binder may be similar to those of the positive electrode binder. Details of the negative electrode conductor may be similar to those of the positive electrode conductor. A method of forming the negative electrode active material layer 22B is not particularly limited, and may include, for example, any one or more of methods including, without limitation, a coating method, a vapor-phase method, a liquid-phase method, a thermal spraying method, and a firing or sintering method.

The negative electrode active material may include a carbon material, a metal-based material, or both, for example. One reason for this is that this helps to obtain a high energy density. Non-limiting examples of the carbon material may include graphitizable carbon, non-graphitizable carbon, and graphite such as natural graphite or artificial graphite. The metal-based material may be a material that includes, as one or more constituent elements, any one or more elements among metal elements and metalloid elements that are each able to form an alloy with lithium. Non-limiting examples of such metal elements and metalloid elements may include silicon, tin, or both. Note that the metal-based material may be a simple substance, an alloy, a compound, a mixture of two or more thereof, or a material including two or more phases thereof. Non-limiting examples of the metal-based material may include TiSi₂ and SiOₓ (0<x≤2 or 0.2<x<1.4).

The separator 23 may be an insulating porous film interposed between the positive electrode 21 and the negative electrode 22, as illustrated in FIG. 7. The separator 23 may allow lithium ions to pass therethrough while preventing a short circuit between the positive electrode 21 and the negative electrode 22. The separator 23 may include a polymer compound, such as polyethylene.

The electrolyte may be an electrolytic solution that includes a solvent and an electrolyte salt. The solvent may include any one or more of non-aqueous solvents, or organic solvents, including, without limitation, a carbonic-acid-ester-based compound, a carboxylic-acid-ester-based compound, and a lactone-based compound. An electrolytic solution including any of the non-aqueous solvents may be what is called a non-aqueous electrolytic solution. In some embodiments, however, the solvent may be an aqueous solvent. The electrolyte salt may include any one or more of light metal salts including, without limitation, a lithium salt. A content of the electrolyte salt is not particularly limited. In some embodiments, the content of the electrolyte salt may be within a range from 0.3 mol/kg to 3 mol/kg both inclusive with respect to the solvent. One reason for this is that this helps to obtain high ion conductivity.

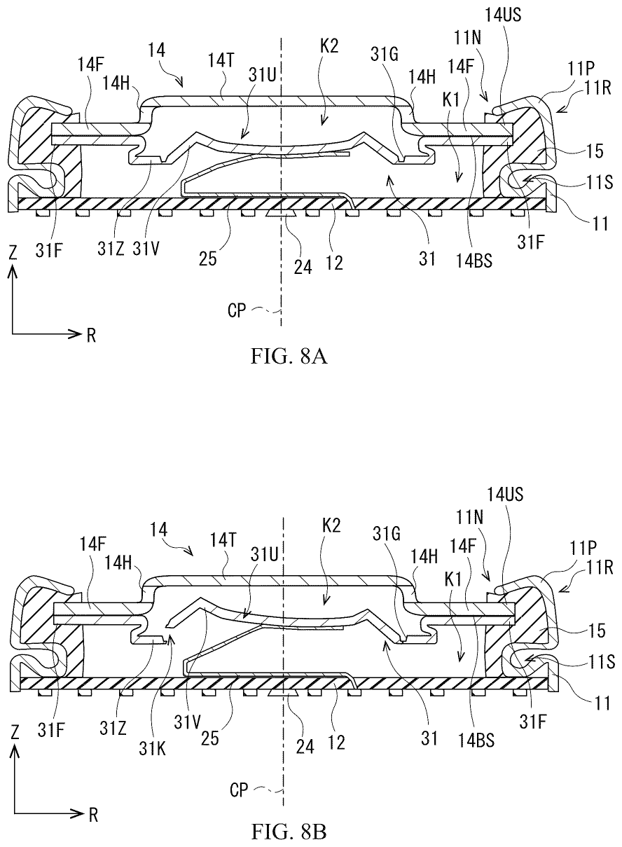

FIGS. 8A and 8B are explanatory diagrams that describe an operation of the secondary battery 1 according to the example embodiment, and more specifically, behavior of the secondary battery 1 at a time when the internal pressure increases. FIGS. 8A and 8B each illustrate a sectional configuration corresponding to FIG. 2. In the following, an operation at a time of charging and discharging will be described first, and thereafter, the operation at the time when the internal pressure increases will be described. In describing the operation, where appropriate, reference will also be made to FIG. 2 as well as FIGS. 8A and 8B.

Upon charging, in the battery device 20, lithium may be extracted from the positive electrode 21, and the extracted lithium may be inserted into the negative electrode 22 via the electrolytic solution. Upon discharging, in the battery device 20, lithium may be extracted from the negative electrode 22, and the extracted lithium may be inserted into the positive electrode 21 via the electrolytic solution. Upon the charging and discharging, lithium may be inserted and extracted in an ionic state.

Upon charging and discharging of the secondary battery 1, when the internal pressure of the battery can 11 increases, the safety cover 31 serving as the safety valve mechanism may operate to prevent the secondary battery 1 from, for example, rupturing or being damaged.

For example, during a normal operation of the secondary battery 1, as illustrated in FIG. 2, the cleavage valve 31V of the safety cover 31 may have not yet cleaved, and thus the cleavage valve 31V and the annular protrusion 31Z may remain integral with each other. Accordingly, the space K2 sandwiched between the battery cover 14 and the safety cover 31 may be closed and separated from the space K1 in which the battery device 20 is contained.

When a gas is generated inside the battery can 11 due to a side reaction such as the decomposition reaction of the electrolytic solution, the generated gas may be accumulated in the space K1 inside the battery can 11 and may cause the internal pressure of the battery can 11 to increase. Accordingly, the safety cover 31 may be deformed, as illustrated in FIG. 8A. For example, the cleavage valve 31V and the annular protrusion 31Z may be displaced in the +Z direction from the battery device 20 toward the protruding part 14T of the battery cover 14. Even in a state of FIG. 8A, however, the cleavage valve 31V of the safety cover 31 may have not yet cleaved and thus the cleavage valve 31V and the annular protrusion 31Z may remain integral with each other. Accordingly, the spaces K1 and K2 may remain separated from each other.

Thereafter, if the generation of the gas inside the battery can 11 continues further, the internal pressure of the battery can 11 may increase further. Here, when the internal pressure of the battery can 11 reaches a certain level or higher, the cleavage valve 31V of the safety cover 31 may partly cleave at, for example, the groove 31G, as illustrated in FIG. 8B. This may form an opening 31K in the safety cover 31 and allow the spaces K1 and K2 to be continuous with each other. As a result, the gas accumulated in the space K1 may move to the space K2 through the opening 31K. When the battery cover 14 has the through hole 14H, the gas moving to the space K2 may further pass through the through hole 14H and be released to the outside of the secondary battery 1.

Even when the battery cover 14 has no through hole 14H, the increase in the internal pressure of the secondary battery 1 may deform the bent part 11P and cause the crimped structure 11R to be broken. As a result, the battery cover 14 may be detached from the battery can 11, and the gas may thus be released to the outside of the secondary battery 1.

First, the positive electrode active material may be mixed with materials including, without limitation, the positive electrode binder and the positive electrode conductor on an as-needed basis to thereby obtain a positive electrode mixture. Thereafter, the positive electrode mixture may be dispersed in a solvent to thereby obtain a positive electrode mixture slurry in paste form. The solvent is not particularly limited in kind, and may be an aqueous solvent or a non-aqueous solvent, e.g., an organic solvent. Thereafter, the positive electrode mixture slurry may be applied on the two opposed surfaces of the positive electrode current collector 21A to thereby form the positive electrode active material layers 21B. Thereafter, the positive electrode active material layers 21B may be subjected to compression molding using, for example, a roll pressing machine. In some embodiments, the positive electrode active material layers 21B may be heated. In some embodiments, the compression molding on the positive electrode active material layers 21B may be performed multiple times. The positive electrode active material layers 21B may thus be formed on the respective two opposed surfaces of the positive electrode current collector 21A. As a result, the positive electrode 21 may be fabricated.

The negative electrode active material layers 22B may be formed on the respective two opposed surfaces of the negative electrode current collector 22A by a procedure similar to that of the positive electrode 21 described above. For example, the negative electrode active material may be mixed with materials including, without limitation, the negative electrode binder and the negative electrode conductor to thereby obtain a negative electrode mixture. Thereafter, the negative electrode mixture may be dispersed in a solvent to thereby obtain a negative electrode mixture slurry in paste form. Details of the solvent may be as described above. Thereafter, the negative electrode mixture slurry may be applied on the two opposed surfaces of the negative electrode current collector 22A to thereby form the negative electrode active material layers 22B. Thereafter, the negative electrode active material layers 22B may be subjected to compression molding using, for example, a roll pressing machine. Details of the compression molding may be as described above. The negative electrode active material layers 22B may thus be formed on the respective two opposed surfaces of the negative electrode current collector 22A. As a result, the negative electrode 22 may be fabricated.

First, the positive electrode lead 25 may be coupled to the positive electrode current collector 21A of the positive electrode 21 by a method such as a welding method. In a similar manner, the negative electrode lead 26 may be coupled to the negative electrode current collector 22A of the negative electrode 22 by a method such as a welding method. Thereafter, the positive electrode 21 and the negative electrode 22 may be stacked on each other with the separator 23 interposed therebetween to form a stacked body, following which the obtained stacked body may be wound to thereby form a wound body having the center space 20C. The wound body may have a configuration similar to that of the battery device 20 except that the positive electrode 21, the negative electrode 22, and the separator 23 are each not impregnated with the electrolytic solution. Thereafter, the center pin 24 may be placed in the center space 20C of the wound body.

Thereafter, the battery can 11 may be prepared, following which the insulating plates 12 and 13 may be opposed to each other with the wound body interposed therebetween, and the wound body, together with the insulating plates 12 and 13, may be placed inside the battery can 11. In this case, the positive electrode lead 25 may be coupled to the safety cover 31 by a method such as a welding method, and the negative electrode lead 26 may be coupled to the battery can 11 by a method such as a welding method.

Thereafter, the electrolytic solution may be injected into the battery can 11 to thereby impregnate the wound body with the electrolytic solution. Thus, the positive electrode 21, the negative electrode 22, and the separator 23 may each be impregnated with the electrolytic solution, and the battery device 20 may be fabricated. Thereafter, the battery cover 14 may be placed on the safety cover 31, following which the flange 14F of the battery cover 14 and the flange 31F of the safety cover 31 may be welded to each other by laser irradiation. Thereafter, the safety cover 31 and the battery cover 14 may be placed inside the battery can 11 together with the gasket 15.

Thereafter, at the open end part 11N of the battery can 11, as illustrated in FIG. 1, the open end part 11N and both the battery cover 14 and the safety cover 31 may be crimped to each other, with the gasket 15 interposed between the open end part 11N and both the battery cover 14 and the safety cover 31. The bent part 11P may thus be formed, and the crimped structure 11R may thereby be formed. As a result, the battery can 11 may be closed by the battery cover 14 to finish the assembly of the secondary battery 1.

The secondary battery 1 having been assembled may be charged and discharged.

Various conditions including, for example, an environment temperature, the number of times of charging and discharging (the number of cycles), and charging and discharging conditions may be set as desired. A film may thus be formed on a surface such as a surface of the negative electrode 22. This may bring the secondary battery 1 into an electrochemically stable state. As a result, the secondary battery 1 of the cylindrical type may be completed in which the battery device 20 and other components are sealed inside the battery can 11.

In the secondary battery 1 according to the example embodiment, the cleavage valve 31V of the safety cover 31 opposed to the battery cover 14 includes the depressed part 31U depressed relative to the battery cover 14. Further, the secondary battery 1 is so configured that the maximum diameter D1 of the depressed part 31U, the maximum diameter D2 of the space K2, and the height H1 of the space K2 in the Z direction satisfy Expressions (1) and (2). This helps to allow the cleavage valve 31V to be accurately deformed when the internal pressure of the battery can 11 increases, and allow the cleavage valve 31V to cleave when the internal pressure of the battery can 11 reaches a desired magnitude. Accordingly, the secondary battery 1 helps to secure high safety.

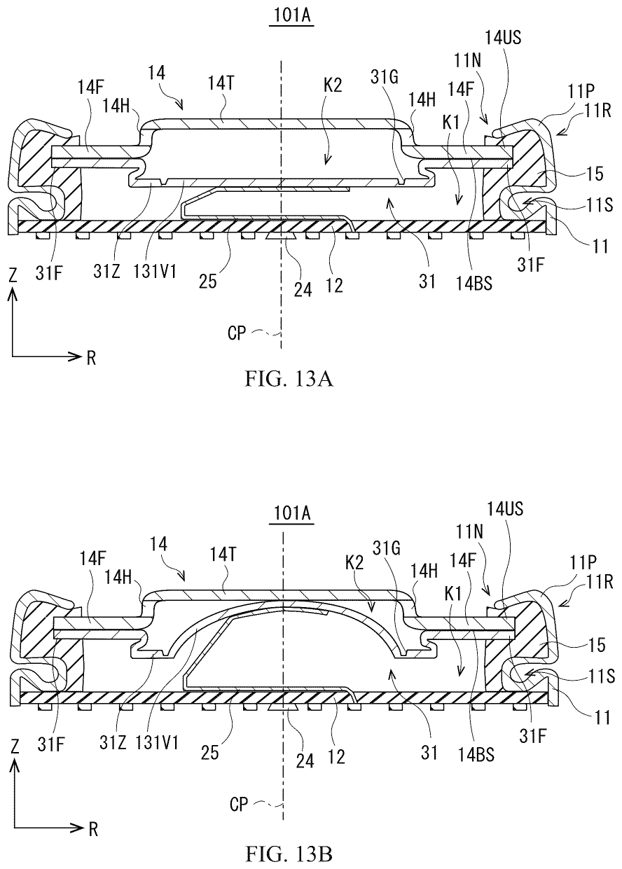

Here, suppose a case with a cleavage valve 131V1 provided in a secondary battery 101A according to a first reference example illustrated in FIG. 13A. The cleavage valve 131V1 may be entirely flat, without any depressed part. With such a configuration, when the internal pressure of the secondary battery 101A increases due to gas generation, the cleavage valve 131V1 can interfere with the battery cover 14 as illustrated in FIG. 13B, before breakage of the cleavage valve 131V1. This can result in failure of a gas releasing operation even if the internal pressure of the battery can 11 has reached a magnitude at which the gas accumulated in the space K1 should be released to the outside by causing the cleavage valve 131V1 to cleave.

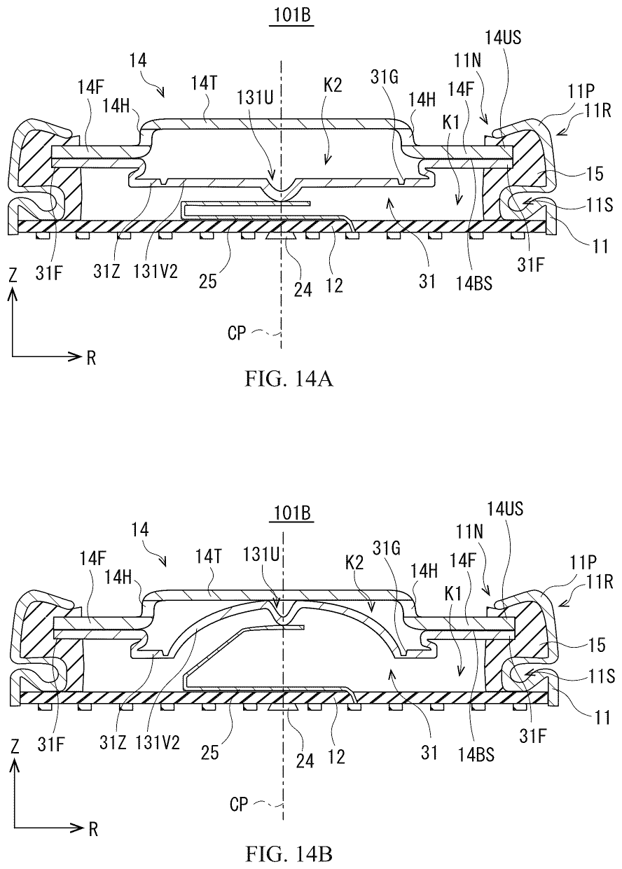

Further, suppose a case with a cleavage valve 131V2 provided in a secondary battery 101B according to a second reference example illustrated in FIG. 14A. The cleavage valve 131V2 may include a depressed part 131U that is not sufficiently large in size. With such a configuration, when the internal pressure of the secondary battery 101B increases due to gas generation, the cleavage valve 131V2 can interfere with the battery cover 14 as illustrated in FIG. 14B, before breakage of the cleavage valve 131V2. This can result in failure of the gas releasing operation even if the internal pressure of the battery can 11 has reached the magnitude at which the gas accumulated in the space K1 should be released to the outside by causing the cleavage valve 131V2 to cleave.

In contrast, in the secondary battery 1 according to the example embodiment, a ratio of the maximum diameter D1 of the depressed part 31U to the maximum diameter D2 of the space K2 is 0.21 or more. This helps to avoid contact of the bottom part 31UB of the depressed part 31U with the battery cover 14 even when the cleavage valve 31V is deformed by the internal pressure of the battery can 11. Further, the ratio of the maximum diameter D1 of the depressed part 31U to the maximum diameter D2 of the space K2 is 0.68 or less. This helps to allow the cleavage valve 31V to be deformed with high sensitivity to the internal pressure of the battery can 11, and thus helps to allow the cleavage valve 31V to stably cleave when the internal pressure of the battery can 11 reaches a desired magnitude.

Further, in the secondary battery 1 according to the example embodiment, a ratio of the height H1 of the space K2 in the Z direction to the maximum diameter D2 of the space K2 is 0.19 or more. This helps to avoid contact of the bottom part 31UB of the depressed part 31U with the battery cover 14 even when the cleavage valve 31V is deformed by the internal pressure of the battery can 11. Further, the ratio of the height H1 of the space K2 in the Z direction to the maximum diameter D2 of the space K2 is 0.35 or less. This helps to secure a sufficient proportion of a volume of the battery device 20 in the battery can 11. Accordingly, the secondary battery 1 helps to achieve high safety while retaining the battery capacity.

In some embodiments, in the secondary battery 1, a ratio of a maximum diameter D3 of the cleavage valve 31V to the maximum diameter D1 of the depressed part 31U may be 1.46 or more. This helps to hold down a pressure (i.e., a cleavage pressure) at which the cleavage valve 31V is to cleave. Further, in some embodiments, the ratio of the maximum diameter D3 of the cleavage valve 31V to the maximum diameter D1 of the depressed part 31U may be 1.87 or less. This helps to sufficiently avoid contact of the bottom part 31UB of the depressed part 31U with the battery cover 14.

In some embodiments, in the secondary battery 1, the opposed surface 31S of the depressed part 31U may include the curved surface protruding toward the battery device 20. This helps to achieve higher strength of joining between the opposed surface 31S and the positive electrode lead 25. In some embodiments, the distance H2 may be greater than or equal to 5 μm and less than or equal to 20 μm. This helps to enhance yield in a process of welding the opposed surface 31S and the positive electrode lead 25 to each other during manufacture.

In some embodiments, in the secondary battery 1, the depressed part 31U may include the stepped parts SP1 and SP2 in the region including the outer edge of the bottom part 31UB and the vicinity of the outer edge of the bottom part 31UB. This helps to reduce a displacement amount of the depressed part 31U relative to a displacement amount of a part of the cleavage valve 31V other than the depressed part 31U when the internal pressure of the battery can 11 increases. Accordingly, contact of the depressed part 31U with the battery cover 14 is sufficiently avoidable even when the internal pressure of the battery can 11 increases. This helps to allow the cleavage valve 31V to stably cleave when the internal pressure of the battery can 11 reaches a desired magnitude.

In some embodiments, in the secondary battery 1, the positive electrode 21 may include the lithium phosphoric acid compound having the olivine crystal structure. This helps to prevent the secondary battery 1 from easily exhibiting the thermal runaway, and also to prevent the battery capacity from easily decreasing even if the secondary battery 1 is repeatedly charged and discharged, which in turn helps to achieve higher operation reliability. In some embodiments, the positive electrode 21 may include a nickel-cobalt composite oxide of a layered rock-salt crystal structure. This helps to obtain a battery that is superior in balance between a large output characteristic and an energy density.

In some embodiments, the secondary battery 1 may be a lithium-ion secondary battery. This helps to allow a sufficient battery capacity to be obtained stably through insertion and extraction of lithium, which in turn helps to achieve higher operation reliability.

The configuration of the secondary battery 1 is appropriately modifiable including as described below according to an embodiment. Note that any two or more of the following series of modification examples may be combined with each other.

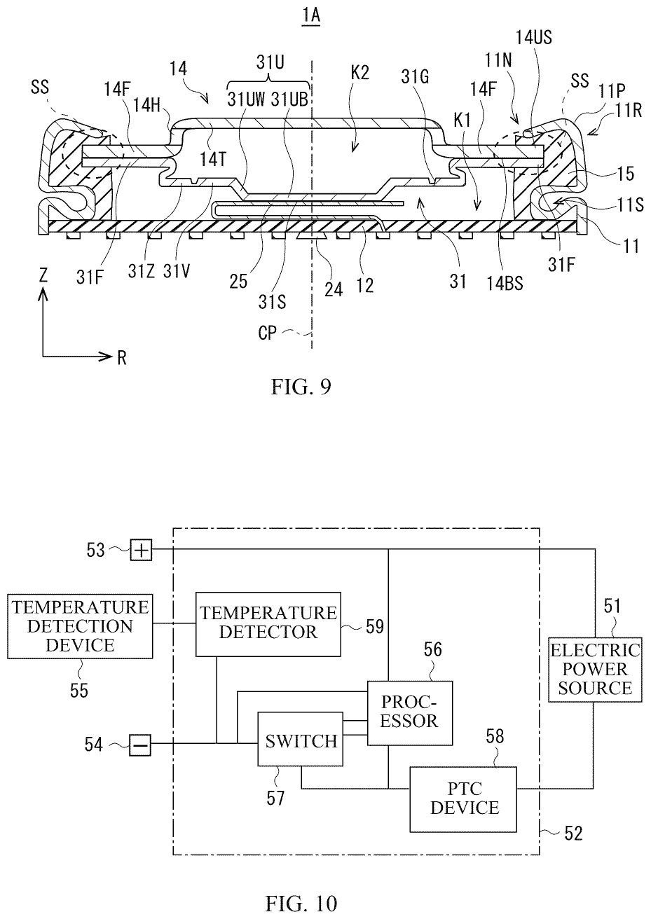

In the secondary battery 1 according to the example embodiment described above, the opposed surface 31S of the depressed part 31U of the cleavage valve 31V may include a curved surface. In some embodiments, however, the opposed surface 31S of the depressed part 31U may include a flat surface alone, as in a secondary battery 1A according to a first modification example illustrated in FIG. 9.

In the example embodiment described above, the secondary battery 1 may include the electrolytic solution, i.e., a liquid electrolyte. In some embodiments, however, the secondary battery 1 may include an electrolyte layer, i.e., a gel electrolyte, instead of the electrolytic solution.

In the battery device 20 including the electrolyte layer, the positive electrode 21 and the negative electrode 22 may be stacked on each other with the separator 23 and the electrolyte layer interposed therebetween, and the stack of the positive electrode 21, the negative electrode 22, the separator 23, and the electrolyte layer may be wound. The electrolyte layer may be interposed between the positive electrode 21 and the separator 23, and between the negative electrode 22 and the separator 23.

For example, the electrolyte layer may include a polymer compound together with the electrolytic solution. The electrolytic solution may be held by the polymer compound in the electrolyte layer. One reason for this is that the leakage of the electrolytic solution is prevented. The electrolytic solution may have the configuration described above. The polymer compound may include, for example, polyvinylidene difluoride. To form the electrolyte layer, a precursor solution including, without limitation, the electrolytic solution, the polymer compound, and an organic solvent may be prepared, following which the precursor solution may be applied on one side or both sides of the positive electrode 21 and on one side or both sides of the negative electrode 22.

When the electrolyte layer is used also, lithium ions may be movable between the positive electrode 21 and the negative electrode 22 via the electrolyte layer, which helps to achieve similar effects.

Next, a description is given of applications (application examples) of any of the secondary batteries described above.

The applications of the secondary battery are not particularly limited. The secondary battery used as a power source may serve as a main power source or an auxiliary power source in, for example but not limited to, electronic equipment, an electric vehicle, or any other application in which any embodiment of the present disclosure is usable. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted on, for example but not limited to, electronic equipment; medical electronic equipment; electric vehicles; and electric power storage systems. Non-limiting examples of the electronic equipment may include video cameras, digital still cameras, mobile phones, laptop personal computers, headphone stereos, portable radios, portable information terminals, and any other electronic equipment to which any embodiment of the present disclosure is applicable. Non-limiting examples of the apparatuses for data storage may include backup power sources, memory cards, and any other apparatus for data storage to which any embodiment of the present disclosure is applicable. Non-limiting examples of the electric power tools may include electric drills, electric saws, and any other electric power tool to which any embodiment of the present disclosure is applicable. Non-limiting examples of the medical electronic equipment may include pacemakers, hearing aids, and any other medical electronic equipment to which any embodiment of the present disclosure is applicable. Non-limiting examples of the electric vehicles may include electric automobiles including hybrid automobiles, and any other electric vehicle to which any embodiment of the present disclosure is applicable. Non-limiting examples of the electric power storage systems may include battery systems for home use or industrial use in which electric power is accumulated for a situation such as emergency, and any other electric power storage system to which any embodiment of the present disclosure is applicable. In some embodiments, one secondary battery may be used in each of the above-described applications. In some embodiments, multiple secondary batteries may be used in each of the above-described applications.

In some embodiments, the battery packs may each include a battery cell. In some embodiments, the battery packs may each include an assembled battery. In some embodiments, the electric vehicle may be a vehicle that operates or travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example but not limited to, home appliances and any other electrical appliance.

An application example of the secondary battery will now be described in detail. The configuration of the application example described below is merely an example, and is appropriately modifiable.

FIG. 10 illustrates a block configuration of a battery pack. The battery pack described here may include a single secondary battery, may be what is called a soft pack, and may be mountable on, for example, electronic equipment typified by a smartphone.

As illustrated in FIG. 10, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be couplable to outside via the positive electrode terminal 53 and the negative electrode terminal 54, and may thus be chargeable and dischargeable. The circuit board 52 may include a processor 56, a switch 57, a thermosensitive resistive device (a PTC device) 58, and a temperature detector 59. However, in some embodiments, the PTC device 58 may be omitted.

The processor 56 may include, for example, a central processing unit (CPU) and a memory, and may control an overall operation of the battery pack. The processor 56 may detect and control a use state of the electric power source 51 on an as-needed basis.

If a voltage of the electric power source 51 (the secondary battery) reaches an overcharge detection voltage or an overdischarge detection voltage, the processor 56 may turn off the switch 57. This helps to prevent a charging current from flowing into a current path of the electric power source 51. For example, the overcharge detection voltage may be 4.2 V±0.05 V and the overdischarge detection voltage may be 2.4 V±0.1 V.

The switch 57 may include, for example, a charge control switch, a discharge control switch, a charging diode, and a discharging diode. The switch 57 may perform switching between coupling and decoupling between the electric power source 51 and external equipment in accordance with an instruction from the processor 56. The switch 57 may include, for example, a metal-oxide-semiconductor field-effect transistor (MOSFET). The charging and discharging currents may be detected based on an ON-resistance of the switch 57.

The temperature detector 59 may include a temperature detection device such as a thermistor. The temperature detector 59 may measure a temperature of the electric power source 51 using the temperature detection terminal 55 and may output a result of the temperature measurement to the processor 56. The result of the temperature measurement to be obtained by the temperature detector 59 may be used, for example, when the processor 56 performs charge and discharge control upon abnormal heat generation or when the processor 56 performs a correction process upon calculating a remaining capacity.

### EXAMPLES

A description is given of Examples of an embodiment of the present disclosure according to an embodiment.

### Example 1

As described below, a joined body of the battery cover 14 and the safety cover 31 applicable to the secondary battery 1 was fabricated, and the fabricated joined body was subjected to evaluation of the cleavage pressure of the safety cover 31.

### <Fabrication of Joined Body>

Samples of the joined body applicable to the secondary battery 1 illustrated in FIG. 1 were each fabricated in accordance with the following procedure.

Specifically, first, the safety cover 31 including aluminum and the battery cover 14 including stainless steel were each prepared. Thereafter, the battery cover 14 was placed on the safety cover 31, following which the flange 14F of the battery cover 14 and the flange 31F of the safety cover 31 were welded to each other by laser irradiation. The joined body was thus obtained. The maximum diameter D1 of the depressed part 31U, the maximum diameter D2 of the space K2, the height H1 of the space K2, and the maximum diameter D3 of the cleavage valve 31V in the safety cover 31 and the battery cover 14 used here had respective values listed in Table 1 to be described later. The distance H2 in the Z direction between the apex 31S1 of the opposed surface 31S and the outer edge 31S2 of the opposed surface 31S was set to 10 μm.

### <Evaluation of Cleavage Pressure>

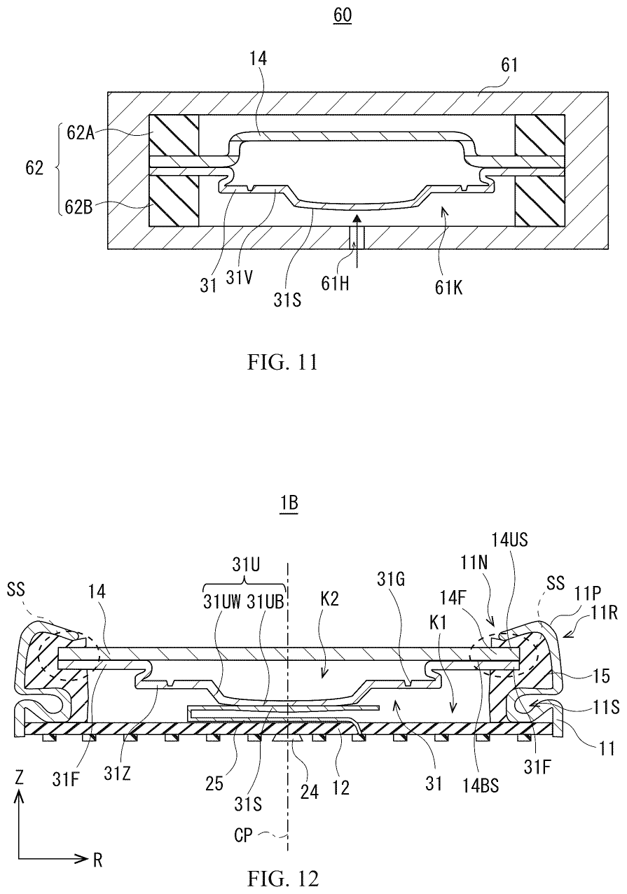

The fabricated samples of the joined body were subjected to evaluation of magnitudes and variations (a standard deviation σ) of the cleavage pressure of the cleavage valve 31 of the safety cover 31 in the following manner, and the evaluation revealed the results presented in Table 1. Specifically, a safety valve cleavage measuring apparatus 60 illustrated in FIG. 11 was used. The joined body of Example 1 was placed in a sealed internal space 61K of the safety valve cleavage measuring apparatus 60, and was fixed with a gripper 62 including a pair of insulators 62A and 62B. In this state, an air pressure was applied through an opening 61H from a side closer to the opposed surface 31S of the safety cover 31, and the magnitude of the cleavage pressure of the cleavage valve 31V was measured. The magnitude of the cleavage pressure was defined as a value of the air pressure at which the cleavage valve 31V cleaved at least partly. As the joined body of Example 1, 32 samples were fabricated and were each subjected to the measurement of the cleavage pressure to determine the standard deviation σ of 32 measured values of the cleavage pressure.

TABLE 1

| | | | | | | | | Cleavage | | Battery |
|---|---|---|---|---|---|---|---|---|---|---|
| | D1 | D2 | D3 | H1 | D1/D2 | H1/D2 | D3/D1 | pressure | σ | capacity |
| | [mm] | [mm] | [mm] | [mm] | [%] | [%] | [%] | [kg/cm²] | [kg/cm²] | [mAh] |
| Comparative | 2.30 | 14.60 | 8.60 | 3.70 | 0.16 | 0.25 | 1.61 | 27.1 | 0.70 | 3000 |
| example 1 | | | | | | | | | | |
| Example 1 | 3.00 | 14.60 | 8.60 | 3.70 | 0.21 | 0.25 | 1.61 | 29.8 | 0.60 | 3000 |
| Example 2 | 5.35 | 14.60 | 8.60 | 3.70 | 0.37 | 0.25 | 1.61 | 35.2 | 0.33 | 3000 |
| Example 3 | 10.00 | 14.60 | 8.60 | 3.70 | 0.68 | 0.25 | 1.61 | 44.9 | 0.50 | 3000 |
| Comparative | 10.70 | 14.60 | 8.60 | 3.70 | 0.73 | 0.25 | 1.61 | 60.0 | 0.70 | 3064 |
| example 2 | | | | | | | | | | |
| Comparative | 5.35 | 14.60 | 8.60 | 2.50 | 0.37 | 0.17 | 1.61 | 35.2 | 0.70 | 3048 |
| example 3 | | | | | | | | | | |
| Example 4 | 5.35 | 14.60 | 8.60 | 2.80 | 0.37 | 0.19 | 1.61 | 35.2 | 0.60 | 2925 |
| Example 5 | 5.35 | 14.60 | 8.60 | 5.10 | 0.37 | 0.35 | 1.61 | 35.2 | 0.32 | 2899 |
| Comparative | 5.35 | 14.60 | 8.60 | 5.60 | 0.37 | 0.38 | 1.61 | 35.2 | 0.33 | 3000 |
| example 4 | | | | | | | | | | |
| Example 6 | 5.35 | 14.60 | 7.60 | 3.70 | 0.37 | 0.25 | 1.42 | 61.2 | 0.60 | 3000 |
| Example 7 | 5.35 | 14.60 | 7.80 | 3.70 | 0.37 | 0.25 | 1.46 | 44.9 | 0.60 | 3000 |
| Example 8 | 5.35 | 14.60 | 10.00 | 3.70 | 0.37 | 0.25 | 1.87 | 29.8 | 0.50 | 3000 |
| Example 9 | 5.35 | 14.60 | 10.20 | 3.70 | 0.37 | 0.25 | 1.91 | 44.5 | 0.65 | 3000 |

* H2 = 10 μm

### Examples 2 to 9 and Comparative Examples 1 to 4

Samples of the joined bodies of Examples 2 to 9 and Comparative examples 1 to 4 were each fabricated in a similar manner to Example 1, except that at least one of the maximum diameter D1 of the depressed part 31U, the maximum diameter D2 of the space K2, the height H1 of the space K2, or the maximum diameter D3 of the cleavage valve 31V was changed as listed in Table 1, and the fabricated samples were each subjected to the evaluation of the cleavage pressure similar to that in Example 1. The results of the evaluation are also presented in Table 1.

### Examples 10 to 14

Samples of the joined bodies of Examples 10 to 14 were each fabricated in a similar manner to Example 2, except that the distance H2 was changed as listed in Table 2. In Example 14, the opposed surface 31S of the safety cover 31 was a flat surface, not a curved surface. Further, in each of the fabricated samples of the joined bodies, the positive electrode lead 25 including aluminum was welded at four spots on the opposed surface 31S of the safety cover 31. A sample in which at least one of the four welding spots was in an insufficiently welded state was evaluated as having a welding defect. Twenty samples were fabricated for each of the joined bodies of Examples 10 to 14 to determine a welding defect rate. For Example 2, twenty samples were also fabricated in a similar manner, the positive electrode lead 25 including aluminum was welded at four spots on the opposed surface 31S of each of the samples, and the welding defect rate was determined in a similar manner. The results for these Examples are also presented in Table 2.

TABLE 2

| | | | | | | | | | Welding |
|---|---|---|---|---|---|---|---|---|---|
| | D1 | D2 | D3 | H1 | D1/D2 | H1/D2 | D3/D1 | H2 | defect |
| | [mm] | [mm] | [mm] | [mm] | [%] | [%] | [%] | [μm] | rate [%] |
| Example 10 | 5.35 | 14.60 | 8.60 | 3.70 | 0.37 | 0.25 | 1.61 | 30 | 10 |
| Example 11 | 5.35 | 14.60 | 8.60 | 3.70 | 0.37 | 0.25 | 1.61 | 20 | 0 |
| Example 2 | 5.35 | 14.60 | 8.60 | 3.70 | 0.37 | 0.25 | 1.61 | 10 | 0 |
| Example 12 | 5.35 | 14.60 | 8.60 | 3.70 | 0.37 | 0.25 | 1.61 | 5 | 0 |
| Example 13 | 5.35 | 14.60 | 8.60 | 3.70 | 0.37 | 0.25 | 1.61 | 3 | 2 |
| Example 14 | 5.35 | 14.60 | 8.60 | 3.70 | 0.37 | 0.25 | 1.61 | 0 | 25 |

As indicated in Table 1, each of Examples 1 to 9 satisfying the conditions that 0.21≤D1/D2≤0.68 and 0.19≤H1/D2≤0.35 achieved a reduction in the variations (standard deviation c) of the cleavage pressure while holding down the cleavage pressure, as compared with Comparative examples 1 to 4. More specifically, in each of Examples 1 to 9, the maximum diameter D1 of the depressed part 31U, the maximum diameter D2 of the space K2, and the height H1 of the space K2 were set to respective appropriate values, which made it possible to perform a stable cleavage operation at a desired pressure. It was thus confirmed that the secondary battery according to an embodiment of the present disclosure made it possible to achieve higher reliability.

Further, based on comparisons between Examples 2 and 6 to 9, it was confirmed that Examples 2, 7, and 8 each satisfying the condition that 1.46≤D3/D1≤1.87 made it possible to reduce both the cleavage pressure and the variations (standard deviation σ) thereof, as compared with Examples 6 and 9 not satisfying the condition that 1.46≤D3/D1≤1.87.

Moreover, based on the results for Examples 2 and 10 to 14 presented in Table 2, it was confirmed that the welding defect was avoidable when the distance H2 was greater than or equal to 5 μm and less than or equal to 20 μm.

Although some embodiments of the present disclosure have been described hereinabove with reference to some example embodiments and Examples, the configuration of an embodiment of the present disclosure is not limited to the configurations described in relation to the example embodiments and Examples above, and is therefore modifiable in a variety of ways.

For example, the description has been given of the case where the battery device has a device structure of a wound type. However, the device structure of the battery device is not particularly limited. In some embodiments, the device structure may thus be another device structure such as a stacked type in which the electrodes, i.e., the positive electrode and the negative electrode, are stacked on each other, or a zigzag folded type in which the electrodes, i.e., the positive electrode and the negative electrode, are folded in a zigzag manner.

Further, although the description has been given of the case where the electrode reactant is lithium, the electrode reactant is not particularly limited. In some embodiments, the electrode reactant may be another alkali metal such as sodium or potassium, as described above. In some embodiments, the electrode reactant may be an alkaline earth metal such as beryllium, magnesium, or calcium, as described above. In some embodiments, the electrode reactant may be another light metal such as aluminum.

In the example embodiment described above, the battery cover 14 as the cover member includes the protruding part 14T as the first middle part; however, the secondary battery of an embodiment of the present disclosure is not limited to that of such an example embodiment. In some embodiments, as in a secondary battery 1B according to a second modification example illustrated in FIG. 12, the battery cover 14 may be a flat plate-shaped member with no protruding part 14T. Even in such a case, satisfying Expressions (1) and (2) helps to allow the safety cover 31 to be accurately deformed when the internal pressure of the battery can 11 increases, and allow the cleavage valve to cleave when the internal pressure of the battery can 11 reaches a desired magnitude.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. The following configurations of the present disclosure are provided according to an embodiment.

<1>

A secondary battery including:
a battery device;
a container containing the battery device, the container including a first end part and a second end part, the first end part being open, the second end part being positioned on an opposite side to the first end part in a first direction and closed; and
a cover member attached to the container to close the first end part, with an insulating member interposed between the container and the cover member; and
a valve member attached to the container to close the first end part, with the insulating member interposed between the container and the valve member, the valve member being positioned between the cover member and the battery device in the first direction, in which
the cover member includes a first flange and a first middle part, the first flange being annular in plan shape along a plane orthogonal to the first direction, the first middle part being surrounded by the first flange along the plane,
the valve member includes a second flange and a second middle part, the second flange being annular in plan shape along the plane and being in contact with the first flange in the first direction, the second middle part being surrounded by the second flange along the plane and being spaced from and opposed to the first middle part in the first direction,
the second middle part includes a cleavage valve including a depressed part depressed relative to the cover member, and
the secondary battery satisfies Expressions (1) and (2) below:

$$0.21 \leq D 1 / D 2 \leq 0 \text{.68} \qquad ( 1 )$$

$$0.19 \leq H 1 / D 2 \leq 0.35 \qquad ( 2 )$$

where
D1 represents a maximum diameter of the depressed part along the plane,
D2 represents a maximum diameter, along the plane, of a space provided between the first middle part and the second middle part, and
H1 represents a dimension of the space in the first direction.
   <2>

The secondary battery according to <1>, in which
the battery device includes an electrode lead,
the depressed part includes an opposed surface opposed to the battery device,
the opposed surface includes a curved surface protruding toward the battery device, and
the electrode lead is joined to the curved surface.
   <3>

The secondary battery according to <1> or <2>, in which a distance in the first direction between an apex of the curved surface and an outer edge of the curved surface is greater than or equal to 5 micrometers and less than or equal to 20 micrometers.

<4>

The secondary battery according to any one of <1> to <3>, in which the depressed part includes a stepped part in an outer edge region of the opposed surface along the plane.

<5>

The secondary battery according to any one of <1> to <3>, in which the secondary battery further satisfies Expression (3) below:

$$1. 46 \leq D 3 / D 1 \leq 1.87 \qquad ( 3 )$$

where D3 represents a maximum diameter of the cleavage valve along the plane.
   <6>

The secondary battery according to any one of <1> to <5>, in which
the first end part of the container includes a crimp part, and
the cover member is attached to the crimp part, with the insulating member interposed between the cover member and the crimp part.
   <7>

The secondary battery according to any one of <1> to <6>, in which the crimp part pinches a stacked part in the first direction, with the insulating member interposed between the crimp part and the stacked part, the stacked part including the first flange and the second flange stacked on each other.

<8>

The secondary battery according to any one of <1> to <7>, in which the cleavage valve has an outer edge defined by a groove provided in the second middle part.

<9>

The secondary battery according to any one of <1> to <8>, in which
the valve member includes a metal material that includes aluminum (Al), and
the container includes a metal material that includes iron (Fe).
   <10>

The secondary battery according to any one of <1> to <9>, in which
the battery device includes a first electrode and a second electrode,
the cover member is electrically coupled to the first electrode via the valve member, and
the container is electrically coupled to the second electrode.

In a secondary battery according to t an embodiment of the present disclosure, a valve member opposed to a cover member includes a second middle part that includes a cleavage valve including a depressed part depressed relative to the cover member. Further, the secondary battery is so configured that a maximum diameter of the depressed part along a plane orthogonal to a first direction, a maximum diameter, along the plane, of a space provided between a first middle part of the cover member and the second middle part of the valve member, and a dimension of the space in the first direction satisfy Expressions (1) and (2). Such a configuration allows the valve member to be accurately deformed when the internal pressure of a container increases, and allows the cleavage valve to cleave when the internal pressure of the container reaches a certain magnitude. The secondary battery according to at least an embodiment of the present disclosure thus makes it possible to secure high safety.

Note that effects of an embodiment of the present disclosure are not necessarily limited to the example effects described above and may include any of a series of effects described herein in relation to the example embodiments of the present disclosure and the modification examples thereof.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The terms “substantially”, “approximately”, “about”, and their variants having the similar meaning thereto are defined as being largely but not necessarily wholly what is specified as understood by one of ordinary skill in the art.

The terms “disposed on”, “provided on”, “formed on”, and their variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device;
a container containing the battery device, the container including a first end part and a second end part, the first end part being open, the second end part being positioned on an opposite side to the first end part in a first direction and closed;
a cover member attached to the container to close the first end part, with an insulating member interposed between the container and the cover member; and
a valve member attached to the container to close the first end part, with the insulating member interposed between the container and the valve member, the valve member being positioned between the cover member and the battery device in the first direction, wherein
the cover member includes a first flange and a first middle part, the first flange being annular in plan shape along a plane orthogonal to the first direction, the first middle part being surrounded by the first flange along the plane,
the valve member includes a second flange and a second middle part, the second flange being annular in plan shape along the plane and being in contact with the first flange in the first direction, the second middle part being surrounded by the second flange along the plane and being spaced from and opposed to the first middle part in the first direction,
the second middle part includes a cleavage valve including a depressed part depressed relative to the cover member, and
the secondary battery satisfies Expressions (1) and (2) below:
$$0.21 \leq D 1 / D 2 \leq 0 \text{.68} \qquad ( 1 )$$
$$0.19 \leq H 1 / D 2 \leq 0.35 \qquad ( 2 )$$
where
D1 represents a maximum diameter of the depressed part along the plane,
D2 represents a maximum diameter, along the plane, of a space provided between the first middle part and the second middle part, and
H1 represents a dimension of the space in the first direction.

2. The secondary battery according to claim 1, wherein
the battery device includes an electrode lead,
the depressed part includes an opposed surface opposed to the battery device,
the opposed surface includes a curved surface protruding toward the battery device, and
the electrode lead is joined to the curved surface.

3. The secondary battery according to claim 1, wherein a distance in the first direction between an apex of the curved surface and an outer edge of the curved surface is greater than or equal to 5 micrometers and less than or equal to 20 micrometers.

4. The secondary battery according to claim 1, wherein the depressed part includes a stepped part in an outer edge region of the opposed surface along the plane.

5. The secondary battery according to claim 1, wherein the secondary battery further satisfies Expression (3) below:
$$1. 46 \leq D 3 / D 1 \leq 1.87 \qquad ( 3 )$$
where D3 represents a maximum diameter of the cleavage valve along the plane.

6. The secondary battery according to claim 1, wherein
the first end part of the container includes a crimp part, and
the cover member is attached to the crimp part, with the insulating member interposed between the cover member and the crimp part.

7. The secondary battery according to claim 1, wherein the crimp part pinches a stacked part in the first direction, with the insulating member interposed between the crimp part and the stacked part, the stacked part including the first flange and the second flange stacked on each other.

8. The secondary battery according to claim 1, wherein the cleavage valve has an outer edge defined by a groove provided in the second middle part.

9. The secondary battery according to claim 1, wherein
the valve member includes a metal material that includes aluminum (Al), and
the container includes a metal material that includes iron (Fe).

10. The secondary battery according to claim 1, wherein
the battery device includes a first electrode and a second electrode,
the cover member is electrically coupled to the first electrode via the valve member, and
the container is electrically coupled to the second electrode.
